(19) United States
(12) Patent Application Publication
(10) Pub. No.: US 2006/0026029 A1
(43) Pub. Date: Feb. 2, 2006

(54) Browser based database access and administration method for virtual databases and virtual communities

(76) Inventors: Cristina Frances Feria, North York (CA); Analiza Cecilio, Markham (CA); Blanca Betty Gallo, Sherbrooke (CA)

Correspondence Address: CRISTINA FERIA, 269 FINCH AVE. EAST, NORTH YORK, ON, M2N 4S1, CA

(21) Appl. No.: 11/178,522

(22) Filed: Jul. 12, 2005

(30) Foreign Application Priority Data
Aug. 2, 2004 (CA) 2,475,127

(51) Int. Cl. G06Q 99/00

(52) U.S. Cl. 705/1

(57) ABSTRACT

This is a system and method of using an alternative to Business Intelligence and Data Mining Tools that are not only expensive but also hard to use. This not only simplifies getting information from the database to aid business decision making but also extends the usability and connectivity to the business' base database outside the business base through a device that can connect to the internet and run an internet browser. This system will also allow multiple users to access data at the same time from several locations.

### TECHNICAL FIELD

This method relates to access of data from existing databases remotely via a PDA or any internet connected device. This method will simplify data mining and business intelligence gathering for users that needs to get information from their databases. This will also extend the ability of these users to have access to their data regardless where they are.

### BACKGROUND ON THE INVENTION

Today, several business intelligence tools that are available are very complicated to use. Although powerful, administrators and users still cannot deliver simple information to the users. With this method, without the use of business intelligence tools, the users of databases will still be able to get the timely information they need without the complexity of using business intelligence tools. By utilizing existing views in any database and accessing them by the methods contained herein, mining data on a database will be made simple and more accessible.

### SUMMARY OF THE INVENTION

The method in this invention will simplify data mining to collect business database information that will be used for reporting and better decision making. By utilizing existing or new database views native to any database and the method described herein to access them, users can have timely, accurate information regardless of where they are in the world as long as they have a device with a database browser and internet access.

### BRIEF DESCRIPTIONS OF THE DRAWINGS

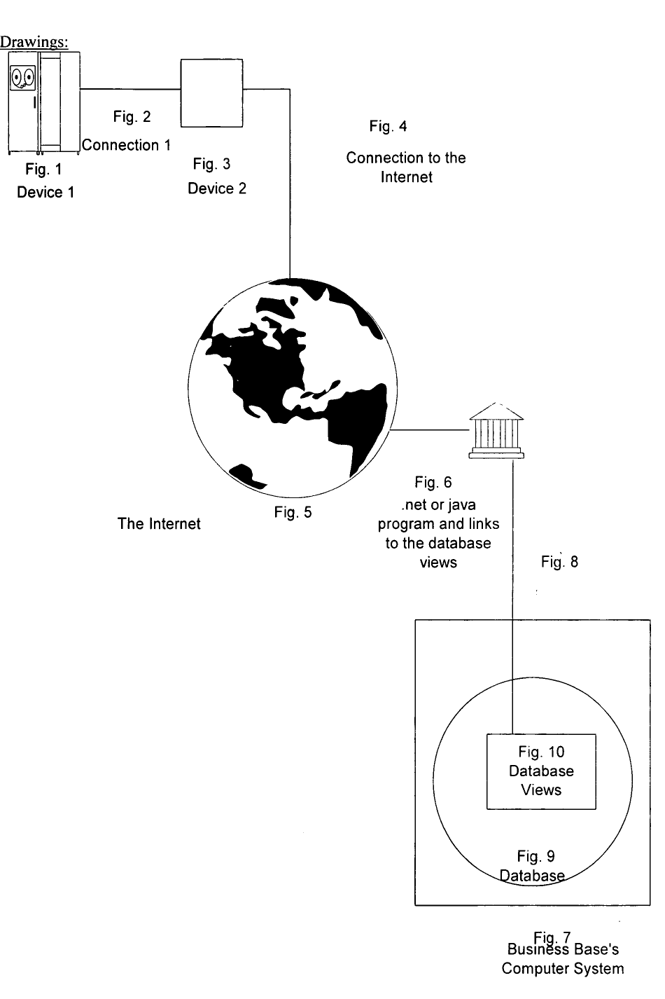

1) FIG. 1 is a device that can run an internet browser and has capabilities to connect to the internet.

2) FIG. 2 may be a connection to a phone on a land line, a Bluetooth device an 802.11 b wireless connection, a Local Area network connection.

3) FIG. 3 may be a phone connecting to the internet via a land line, a phone with Bluetooth capability connecting to the internet via GPRS (General Packet Radio Service), a router connecting directly to the internet.

4) FIG. 4 is a connection to the internet.

5) FIG. 5 is the internet

6) FIG. 6 is a connection spawned by a net or java connection from the internet browser mentioned in FIG. 1.

7) FIG. 7 is a computer system of any platform that exist in the base of the business.

8) FIG. 8 is a connection from FIG. 6 to FIG. 7's database system

9) FIG. 9 is the database system that exists in the computer system in FIG. 7.

10) FIG. 10 is a set of database views that can be pre-defined or defined later.

### DETAILED DESCRIPTION

The device described in FIG. 1 first needs to connect to the internet (FIG. 2) via a phone connected to a land line, a phone that has Bluetooth and GPRS capability, a Wireless 802.11b LAN, or a directly connected Local Area Network (FIG. 3). Once a connection is established (FIG. 4) to the internet (FIG. 5), running a browser on the device (FIG. 1) will connect the user to the base of the business' computer (FIG. 7) by typing in the correct IP, a connection to the database (FIG. 8) is established as initiated by the .net or java application (FIG. 6). Once connected to the database (FIG. 9), the net or java application (FIG. 6) will give access to the databases' views (FIG. 10). The views (FIG. 10) can be pre-defined or defined later by a database administrator defining various database information that can be used for business intelligence purposes. Thereby eliminating the use for more expensive and more complicated business intelligence tools, giving the same information that will be needed to in the information from the database to aid in better business decisions and business forecasting.

The .net or java application (FIG. 6) connects to any database via ODBC or .JDBC to interrogate that database views (FIG. 7), and through the browser bring the result back to the device (FIG. 1). The views defined will be accessible to the user using the device (FIG. 1).

ODBC and JDBC are existing common database access methods that connects to databases and get information from them.

1) A method of getting data to be used for business intelligence just using database views by using net or java written applications which basically interrogates databases via ODBC or JDBC.

2) A method of connecting to a remote database by using a device that connects to the internet and utilizes an internet browser to run a net or java application to connect to the remote database via ODBC or JDBC to interrogate database views and return the contents of the views back to the internet connected device.

3) A method to use the contents of the views for decision making purposes for a business or activity.
